(19) United States
(12) Patent Application Publication
(10) Pub. No.: US 2018/0242433 A1
(43) Pub. Date: Aug. 23, 2018

(54) INFORMATION ACQUISITION METHOD, ILLUMINATION DEVICE AND ILLUMINATION SYSTEM

(71) Applicant: ZHEJIANG SHENGHUI LIGHTING CO., LTD, Jiaxing (CN)

(72) Inventors: Bin LIU, Jiaxing (CN); Jinxiang SHEN, Jiaxing (CN)

(21) Appl. No.: 15/753,054

(22) PCT Filed: Mar. 9, 2017
(86) PCT No.: PCT/CN2017/076171

§ 371 Date: Feb. 15, 2018

(30) Foreign Application Priority Data
Mar. 16, 2016 (CN) 201610153158.1

(51) Int. Cl. H05B 37/02; G08C 17/02; H04L 29/08; H04W 4/00

(52) U.S. Cl. CPC H05B 37/0272; G08C 17/02; G08C 2201/93; H04W 4/00; H04L 67/12

(57) ABSTRACT

The present disclosure provides an information acquisition method, an illumination device and an illumination system. The method includes: acquiring, by the illumination device, an input command inputted by the user, the input command including a to-be-processed information identifier; generating, by the illumination device, according to a to-be-processed file, the input command and sending the to-be-processed file to the processing unit; the to-be-processed file includes the to-be-processed information identifier, and the to-be-processed file being configured to instruct the processing unit to acquire the first information corresponding to the to-be-processed information identifier; receiving, by the illumination device, the first information sent by the processing unit, and outputting the first information.

### CROSS-REFERENCES TO RELATED APPLICATIONS

This application claims the priority of Chinese Patent Application No. 201610153158.1 filed on Mar. 16, 2016, the entire content of which is incorporated herein by reference.

### FIELD OF THE DISCLOSURE

The present disclosure relates to electronic technologies and, more particularly, relates to an information acquisition method, an illumination device and an illumination system.

### BACKGROUND

As people desire a higher quality of spiritual life, reading materials have become an indispensable part of people's daily life. In the spare time, people often enrich their spiritual life by reading books and newspapers, or other methods.

When people read reading materials, upon encountering an unknown or unfamiliar word, they often look up the word in a dictionary to obtain information corresponding to the word (e.g., pronunciation, definition, etc.).

However, in current techniques, when people are trying to acquire information corresponding to a word from a reading material, they often need to manually look up the word in a dictionary to obtain the information corresponding to the word. Accordingly, people's efficiency in acquiring information corresponding to the word from the reading material may be relatively low, resulting in a relatively low reading efficiency.

### BRIEF SUMMARY OF THE DISCLOSURE

The present disclosure provides an information acquisition method, an illumination device and an illumination system, which are used to solve technical issues in existing techniques regarding a relatively low efficiency for people to acquire information corresponding to a word from a reading material, as well as a relatively low efficiency for people to read a reading material.

One aspect of the present disclosure provides an information acquisition method. The method includes using an illumination device to acquire an input command inputted by a user, where the input command includes a to-be-processed information identifier. Further, the illumination device generates a to-be-processed file according to the input command, and send the to-be-processed file to a processing unit, where the to-be-processed file includes the to-be-processed information identifier and is used to instruct the processing unit to acquire first information corresponding to the to-be-processed information identifier. Further, the illumination device receives the first information sent by the processing unit, and outputs the first information.

Optionally, the to-be-processed file is also used to instruct the processing unit to send a first identifier to the illumination device, where the first identifier is an identifier extracted from the to-be-processed file by the processing unit.

Thus, before the illumination device receives the first information sent by the processing unit, the method further includes using the illumination device to receive the first identifier sent by the processing unit, and output the first identifier to the user. Further, the illumination device acquires confirmation information inputted by the user, where the confirmation information is used to instruct the illumination device that the first identifier is the to-be-processed information identifier. Further, according to the confirmation information, the illumination device sends processing instruction information to the processing unit, where the processing instruction information is used to instruct the processing unit to acquire the first information according to the first identifier.

Optionally, the to-be-processed file is an image file, or an audio file.

Optionally, the to-be-processed information identifier includes a word, a digit, a symbol, or a combination thereof.

Optionally, using the illumination device to acquire the input command inputted by the user specifically includes using the illumination device to acquire the input command inputted by the user via a webcam or microphone.

Optionally, using the illumination device to output the first information specifically includes using the illumination device to output the first information via a speaker device or a display screen.

Another aspect of the present disclosure provides another information acquisition method. The method includes using a processing unit to receive a to-be-processed file sent by the illumination device, where the to-be-processed file includes a to-be-processed information identifier and is used to instruct the processing unit to acquire first information corresponding to the to-be-processed information identifier. Further, the processing unit acquires the first information corresponding to the to-be-processed information identifier according to the to-be-processed file. Further, the processing unit send the first information to the illumination device.

Optionally, the to-be-processed file is also used to instruct the processing unit to send a first identifier to the illumination device, where the first identifier is an identifier extracted from the to-be-processed file by the processing unit.

Thus, before using the processing unit to acquire the first information corresponding to the to-be-processed information identifier, the method further includes: using the processing unit to extract the first identifier from the to-be-processed file, and sending the first identifier to the illumination device. Further, the processing unit receives processing instruction information sent by the illumination device, where the processing instruction information is used to instruct the processing unit to acquire the first information according to the first identifier.

Optionally, after using the processing unit to acquire the first information corresponding to the to-be-processed information identifier, the method further includes using the processing unit to update a number of acquisitions of the first information. Further, the processing unit updates a storage location of the first information in the processing unit according to the updated number of acquisitions of the first information.

Optionally, the to-be-processed file also includes an identifier of the illumination device.

Thus, after the processing unit acquires the first information corresponding to the to-be-processed information identifier, the method further includes using the processing unit to generate a study note. The study note includes the to-be-processed information identifier, the first information corresponding to the to-be-processed information identifier, and the identifier of the illumination device.

Optionally, the to-be-processed file is an image file or an audio file.

Optionally, when the to-be-processed file is the image file, using the processing unit to extract the first identifier from the to-be-processed file specifically includes using the processing unit to perform image recognition processing on the image file and acquire the first identifier from the processed image file.

Another aspect of the present disclosure provides an illumination device, the illumination device includes an acquisition module, a generation module, a sending module, a receiving module, and an outputting module. The acquisition module is configured to acquire an input command inputted by a user, where the input command includes a to-be-processed information identifier.

The generation module is configured to generate a to-be-processed file according to the input command acquired by the acquisition module. The to-be-processed file includes the to-be-processed information identifier and is used to instruct the processing unit to acquire the first information corresponding to the to-be-processed information identifier.

The sending module is configured to send the to-be-processed file generated by the generation module to the processing unit. The receiving module is configured to receive the first information corresponding to the to-be-processed information identifier sent by the processing unit. The outputting module is configured to output the first information received by the receiving module.

Optionally, the to-be-processed file is also used to instruct the processing unit to send the first identifier to the illumination device, where the first identifier is an identifier extracted from the to-be-processed file by the processing unit. The receiving module is also configured to, before receiving the first information sent by the processing unit, receiving the first identifier sent by the processing unit. The outputting module is also configured to output the first identifier received by the receiving module to the user.

The acquisition module is also configured to acquire confirmation information inputted by the user, where the confirmation information is used to instruct the illumination device that the first identifier is the to-be-processed information identifier. The sending module is also configured to, according to the confirmation information acquired by the acquisition module, send processing instruction information to the processing unit. The processing instruction information is used to acquire the first information according to the first identifier.

Optionally, the to-be-processed file is an image file or an audio file.

Optionally, the to-be-processed information identifier is in a form of words, digits, symbols, or a combination thereof.

Optionally, using the acquisition module to acquire the input command inputted by a user specifically includes using the acquisition module to acquire the input command inputted by the user via a webcam or a microphone.

Optionally, using the output module to output the first information received by the receiving module specifically includes using the outputting module to output the first information received by the receiving module via a speaker device or a display screen.

Another aspect of the present disclosure provides an illumination system. The illumination system includes any illumination device and processing unit described above. In particular, the processing unit is configured to execute any of the two information acquisition methods described above.

By using the information acquisition method, illumination device and illumination system provided by the present disclosure, if a user encounters an unknown or unfamiliar word when reading a reading material, the user may input an input command including a to-be-processed information identifier (i.e., an unknown or unfamiliar word) to the illumination device. Thus, after acquiring the input command, the illumination device may, according to the to-be-processed information identifier, acquire first information corresponding to the to-be-processed information identifier and output the first information to the user. Accordingly, the user may automatically acquire the information corresponding to the word via the illumination device. That is, the user may no longer need to manually look up the information corresponding to the word. Thus, the efficiency of the user in acquiring the information corresponding to the word from the reading material may be improved and, further, the efficiency of the user in reading the reading material may be improved.

### BRIEF DESCRIPTION OF THE DRAWINGS

To describe the technical solutions in the embodiments of the present invention or in the prior art more clearly, the accompanying drawings required for describing the embodiments or the prior art are briefly introduced hereinafter. Obviously, the accompanying drawings in the following description are merely some embodiments of the present invention. Those skilled in the art may derive other drawings according to the accompanying drawings without any creative effort.

FIG. 1 illustrates an interactive flow chart of an exemplary information acquisition method consistent with various disclosed embodiments;

FIG. 2 illustrates an interactive flow chart of another exemplary information acquisition method consistent with various disclosed embodiments;

FIG. 3 illustrates a flow chart of another exemplary information acquisition method consistent with various disclosed embodiments;

FIG. 4 illustrates a structural schematic view of an illumination device consistent with various disclosed embodiments; and

FIG. 5 illustrates an exemplary configuration of an illumination device consistent with various disclosed embodiments.

### DETAILED DESCRIPTION

Hereinafter, technical solutions in embodiments of the present disclosure will be described in a clear and complete manner with reference to the accompanying drawings in embodiments of the present disclosure. Obviously, the embodiments described herein are merely a part of, but not entire embodiments of the present disclosure. Based on the embodiments of the present disclosure, other embodiments may be derived by those ordinarily skilled in the art without creative effort, all of which fall within the protection scope of the present disclosure.

For ease of understanding of the present disclosure, an illumination device and a processing unit evolved in the present disclosure are briefly introduced hereinafter. In one embodiment, other than providing an illumination function (e.g., by LED driver circuit and light emitting component), the illumination device may further include an input unit (e.g., a webcam, a microphone, etc.), a wireless transmission module (e.g., a general packet radio service transmission module, a 3G wireless transmission module, a 4G wireless transmission module, a Wi-Fi transmission module, etc.), and an output unit (e.g., a speaker, a display screen, etc.). The aforementioned processing unit may be any device having a processing function, such as a server, a computer, a cloud server, etc. In one embodiment, the processing unit may access a public network and interact with the disclosed illumination device at any time.

The information acquisition method, illumination device and illumination system provided by the present disclosure are aimed at solving technical issues regarding the relatively low efficiency of people in acquiring the information corresponding to a word from a reading material, as well as the relatively low efficiency of people in reading a reading material. Obviously, the disclosed information acquisition method, the illumination device and the illumination system may also be used to acquire information corresponding to digits, symbols, etc. from the reading material, and the present disclosure is not limited thereto.

Hereinafter, specific embodiments are used to illustrate technical solutions of the present disclosure in detail. Various embodiments shown below may be combined with each other, and the same or similar concepts or processes may not be described repeatedly in certain embodiments.

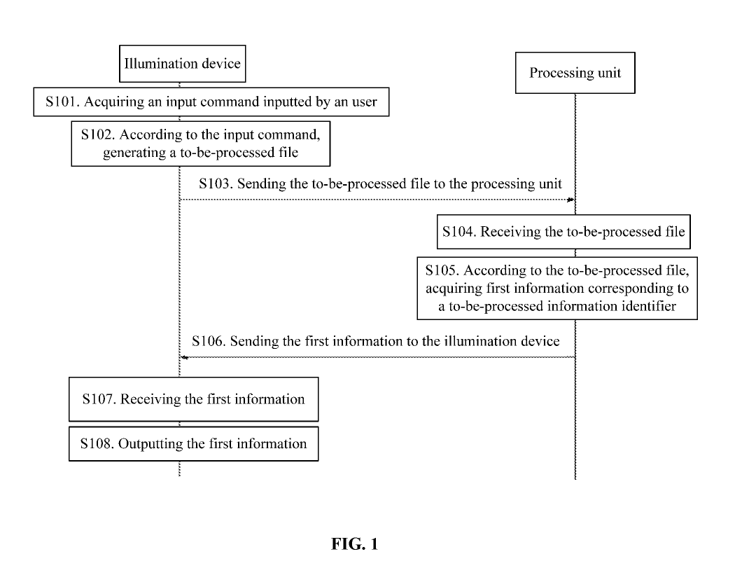

FIG. 1 illustrates an interactive flow chart of an exemplary information acquisition method consistent with various disclosed embodiments. The method relates to a process using an illumination device to acquire first information corresponding to a to-be-processed information identifier via a processing unit. Thus, the efficiency of a user in acquiring the first information corresponding to the to-be-processed information identifier may be improved.

As shown in FIG. 1, the method may include acquiring, by the illumination device, an input command inputted by the user (S101). The input command may include the to-be-processed information identifier.

Specifically, when the user is within a range covered by the input unit of the illumination device, if the user needs to acquire information corresponding to the to-be-processed information identifier, the user may input the input command including the to-be-processed information identifier to the illumination device. Thus, the illumination device may acquire the input command. Optionally, the illumination device may acquire the input command via a webcam, or acquire the input command inputted by the user via a microphone.

When the illumination device acquires the input command via the webcam, the input command may be an operational command pre-configured in the illumination device. The operational command may, for example, be a user clicking the to-be-processed information identifier by hand, or the user sliding below the to-be-processed information identifier by hand, or the user circling the to-be-processed information identifier by a stylus, etc. When the illumination device acquires the input command inputted by the user via the microphone, the input command may be a voice command pre-configured in the illumination device. The voice command may, for example, be the user saying ‘inquiring the to-be-processed information identifier’, or the user saying ‘searching the to-be-processed information identifier’, etc.

In particular, the aforementioned to-be-processed information identifier may, for example, be words. The words may, for example, be a character, a term, a phrase, a sentence, etc. The to-be-processed information identifier may also be digits. The digit may, for example, be a phone number, a customer service number, a zip code, an area code, etc. The to-be-processed information identifier may also be a symbol. The symbol may, for example, be a logo of a certain manufacturer, or a logo of a certain place, etc.

The method may further include generating, by the illumination device, a to-be-processed file according to the input command (S102). The to-be-processed file may include the to-be-processed information identifier, and the to-be-processed file may be used to instruct the processing unit to acquire the first information corresponding to the to-be-processed information identifier.

Specifically, when the illumination device acquires the input command inputted by the user via the webcam, the illumination device may, according to the input command, generate the image file (i.e., the to-be-processed file) including the to-be-processed information identifier. When the illumination device acquires the input command inputted by the user via the microphone, the illumination device may, according to the input command, generate the audio file (i.e., the to-be-processed file) including the to-be-processed information identifier.

Further, the method may include sending, by the illumination device, the to-be-processed file to the processing unit (S103). Specifically, the illumination device may send the to-be-processed file to the processing unit via a wireless transmission module.

In particular, the wireless transmission module may be any module having a wireless transmission function, such as a general packet radio service (GPRS) transmission module, a 3G wireless transmission module, a 4G wireless transmission module, a wireless fidelity (WI-FI) transmission module, etc. In certain implementation, according to the user demand, a suitable wireless transmission module may be determined as the wireless transmission module for the aforementioned illumination device, and the present disclosure is not limited thereto.

Further, the method may include receiving, by the processing unit, the to-be-processed file (S104), and acquiring, by the processing unit, the first information corresponding to the to-be-processed information identifier (S105).

Specifically, in one embodiment, the aforementioned processing unit may have a pre-configured mapping relationship between the to-be-processed information identifier and the first information corresponding to the to-be-processed information identifier. Thus, after the processing unit receives the to-be-processed file sent by the illumination device, the processing unit may, according to the to-be-processed information identifier included in the to-be-processed file, acquire the first information corresponding to the to-be-processed information identifier from the mapping relationship.

Optionally, when the to-be-processed information identifier is words, the first information corresponding to the to-be-processed information identifier may be pinyin, definition, or English translation of the words, etc. When the to-be-processed information identifier is digits, using the digits being a telephone number as an example, the first information corresponding to the to-be-processed information identifier may be a region the telephone number belongs to.

Further, given the digits as a customer service number as an example, the first information corresponding to the to-be-processed information identifier may be a company name that the customer service number belongs to. Given the digits as a zip code or an area code as an example, the first information corresponding to the to-be-processed information identifier may be an area that the zip code or the area code belongs to. When the to-be-processed information identifier is a symbol, the first information corresponding to the to-be-processed information identifier may be a company name, a product name, or a location name, etc. that the symbol belongs to.

Further, the method may include sending, by the processing unit, the first information to the illumination device (S106). Further, the method may include receiving, by the illumination device, the first information (S107). Further, the method may include outputting, by the illumination device, the first information (S108).

Specifically, after the illumination device receives the first information corresponding to the to-be-processed information identifier sent by the processing unit, the first information may be outputted to the user via an output unit. Thus, the user may timely acquire the first information via the output unit of the illumination device. Optionally, the illumination device may output the first information via a speaker device, and may output the first information via a display screen, etc.

In existing techniques, when reading a reading material, if the user encounters an unknown or unfamiliar word, the user often acquires the information corresponding to the word (e.g., pronunciation, definition, etc.) by referring to a dictionary. However, because the speed of the user acquiring the information corresponding to the word via the dictionary is relatively slow, the efficiency of the user in acquiring the information corresponding to the word from the reading material may be relatively low. Thus, the efficiency of the user reading the reading material may be relatively low.

However, using the disclosed information acquisition method, if the user encounters an unknown or unfamiliar word when reading the reading material, the user may send the input command including the to-be-processed information identifier (i.e., a word unknown or unfamiliar to the user) to the illumination device. Thus, the illumination device may, according to the to-be-processed information identifier, acquire the first information corresponding to the to-be-processed information identifier from the processing unit and output the first information to the user.

Accordingly, the user may automatically acquire the information corresponding to the word via the illumination device, and the user may no longer need to manually look up the information corresponding to the word. Thus, the efficiency of people in acquiring the information corresponding to the word from the reading material may be improved, and the efficiency of the user in reading the reading material may be improved.

FIG. 2 illustrates an interactive flow chart of another exemplary information acquisition method consistent with various disclosed embodiments. In one embodiment, the to-be-processed file may also instruct the processing unit to send the first identifier to the illumination device, and the first identifier may be an identifier extracted from the to-be-processed file by the processing unit.

More specifically, after the illumination device receives the first identifier sent by the processing unit, the illumination device may confirm with the user whether the first identifier is the to-be-processed information identifier. Thus, the accuracy of the first information corresponding to the to-be-processed information identifier acquired by the processing unit according to the first identifier may be improved. Based on the aforementioned embodiment, further, between S104 and S105, as shown in FIG. 2, the method may include extracting, by the processing unit, the first identifier from the to-be-processed file (S201).

Specifically, after the processing unit receives the to-be-processed file sent by the illumination device, the aforementioned processing unit may first extract the to-be-processed information identifier included in the to-be-processed file from the to-be-processed file. Thus, the processing unit may, according to the to-be-processed information identifier, acquire the first information corresponding to the to-be-processed information identifier. By then, the to-be-processed information identifier extracted from the to-be-processed file by the processing unit may be the first identifier.

Optionally, when the to-be-processed file is an image file, the aforementioned processing unit may, via an image recognition method, extract the to-be-processed information identifier (i.e., the first identifier) included in the image file from the image file. In particular, the image recognition may, for example, be optical character recognition (OCR), or any image recognition technique in existing techniques. The present disclosure is not limited thereto.

Optionally, when the to-be-processed file sent to the processing unit by the illumination device is an audio file, the processing unit may extract the to-be-processed information identifier (i.e., the first identifier) included in the audio file from the audio file. In particular, the audio recognition here may, for example, refer to any audio recognition technique in existing techniques, and the present disclosure is not limited thereto.

The method may further include sending, by the processing unit, the first identifier to the illumination device (S202). Specifically, as mentioned in the aforementioned embodiments, the to-be-processed file may be an image file or an audio file. When the to-be-processed file is the image file or the audio file, influenced by clarity and viewing angle of the image file, or the pronunciation of the audio file, the first identifier extracted by the processing unit from the to-be-processed file may not be the to-be-processed information identifier.

Using the to-be-processed file being an image file as an example, assume the to-be-processed identifier information in the to-be-processed file includes a word “farmland”. By then, influenced by the clarity and angle of the image file, the first identifier extracted from the to-be-processed file by the processing unit may be “tarmland”.

Accordingly, to ensure that the first identifier acquired by the processing unit is the to-be-processed information identifier, after the processing unit extracts the first identifier from the to-be-processed file, the first identifier may first be sent to the illumination device. Thus, the illumination device may confirm with the user whether the first identifier is the to-be-processed information identifier or not.

The method may further include receiving, by the illumination device, the first identifier (S203), and outputting, by the illumination device, the first identifier to the user (S204). Specifically, after the illumination device receives the first identifier sent by the processing unit, the output unit may send the first identifier to the user. Accordingly, the user may acquire the first identifier via the output unit of the illumination device. Optionally, the illumination device may output the first identifier via the speaker device, or output the first identifier via the display screen, etc.

The method may further include acquiring, by the illumination device, the confirmation information inputted by the user (S205). The confirmation information may be used to instruct the illumination device that the first identifier is the to-be-processed information identifier.

Specifically, when the user confirms that the first identifier is the to-be-processed information identifier, the user may input the confirmation information that instruct the illumination device that the first identifier is the to-be-processed information identifier to the illumination device. Thus, the illumination device may, according to the confirmation information, send the processing instruction information to the processing unit that instructs the processing unit to acquire the first information corresponding to the to-be-processed information identifier according to the first identifier.

In specific implementation, the user may input the confirmation information to the illumination device via the microphone of the illumination device. By then, the confirmation information may be the voice information pre-configured in the illumination device. The voice information may, for example, be a user saying “confirmed” or “search”, etc.

Optionally, when the user confirms that the first identifier is not the to-be-processed information identifier, that is, the first identifier is a wrong identifier, the user may input stopping instruction to the illumination device that is used to indicate that the first identifier is not the to-be-processed information identifier. Thus, the illumination device may, according to the stopping instruction, instruct the processing unit to end the process, or instruct the processing unit to re-extract the to-be-processed information identifier from the to-be-processed file. That is, S201˜S204 may be re-executed, depending on the user demand.

The method may further include sending, by the illumination device, the processing instruction information to the processing unit according to the confirmation information (S206). In particular, the processing instruction information may be used to instruct the processing unit, according to the first identifier, to acquire the first information corresponding to the to-be-processed information identifier.

The method may further include receiving, by the processing unit, the processing instruction information (S207). Specifically, after the processing unit receives the processing instruction information sent by the illumination device, the processing unit may, according to the first identifier, acquire the information corresponding to the first identifier. The information may then be the first information corresponding to the to-be-processed information identifier.

By using this method, the accuracy of the processing unit in acquiring the first information corresponding to the to-be-processed information identifier according to the to-be-processed file may be improved. Accordingly, the efficiency of the user in acquiring the information corresponding to the word from the reading material may be improved and, further, the efficiency of the user in reading the reading material may be improved.

In the information acquisition method provided by the present disclosure, after the illumination device sends the to-be-processed file including the to-be-processed information identifier to the processing unit, the illumination device may receive the first identifier extracted from the to-be-processed file by the processing unit sent by the processing unit. Thus, the illumination device may confirm with the user whether the first identifier is the to-be-processed information identifier or not.

After the user confirms that the first identifier is the to-be-processed information identifier, the illumination device may acquire the information (i.e., the first information corresponding to the to-be-processed information identifier) corresponding to the first identifier via the processing unit. Accordingly, the accuracy of the processing unit in acquiring the first information corresponding to the to-be-processed information identifier according to the to-be-processed file may be improved. The efficiency of the user in acquiring the information corresponding to the word from the reading material may be improved and, further, the efficiency of the user in reading the reading material may be improved.

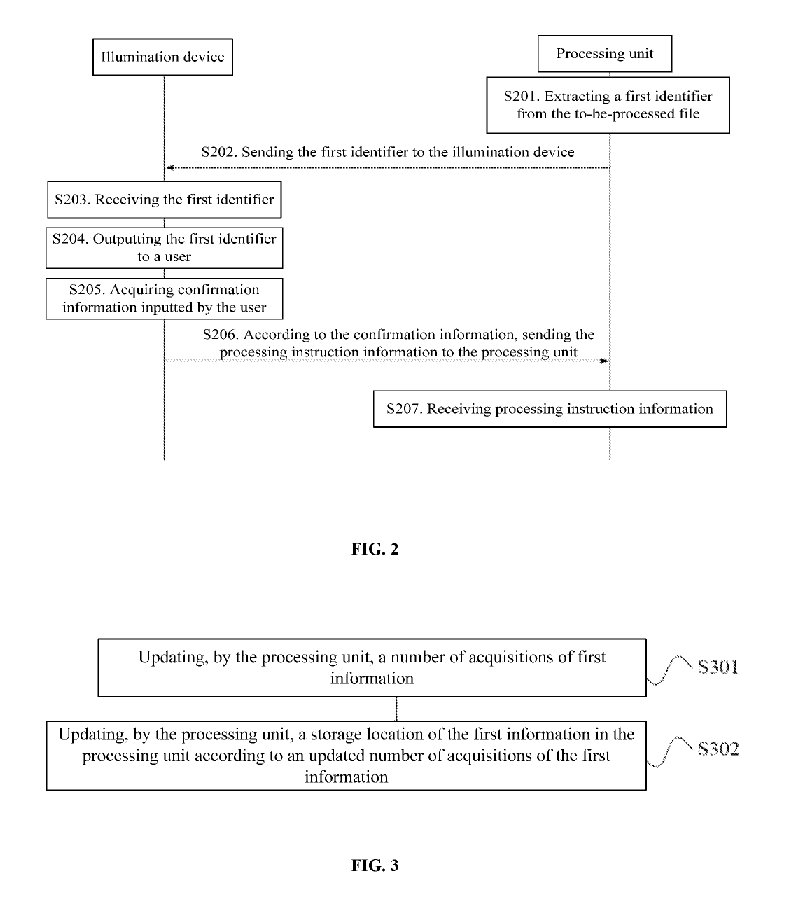

FIG. 3 illustrates a flow chart of another exemplary information acquisition method consistent with various disclosed embodiments. The method relates to a process that after the processing unit acquires the first information corresponding to the to-be-processed information identifier, updating the storage location of the first information in the processing unit according to the number of acquisitions of the first information corresponding to the to-be-processed information identifier.

Based on the aforementioned embodiments, further, after the aforementioned S105, the method may also include updating, by the processing unit, the number of acquisitions of the first information (S301). Specifically, as described in the aforementioned embodiments, the aforementioned processing unit may pre-configure the mapping relationship between the to-be-processed information identifier and the first information corresponding to the to-be-processed information identifier.

In one embodiment, the pre-configured mapping relationship may also include the mapping relationship between the first information corresponding to the to-be-processed information identifier and the number of acquisitions (i.e., number of times that the first information is requested). The number of acquisitions may be the number of the first information corresponding to the to-be-processed information identifier acquired by the processing unit according to the to-be-processed information identifier. In specific implementation, each time after the processing unit acquires the first information corresponding to the to-be-processed information identifier, via the method of counting, the number of acquisitions of the first information in the pre-configured mapping relationship may be updated.

Further, the method may also include updating, by the processing unit according to the updated number of acquisitions of the first information, the storage location of the first information in the processing unit (S302). Specifically, the aforementioned processing unit may compare the updated number of acquisitions of the first information with the number of acquisitions of each information in the processing unit.

When the updated number of acquisitions corresponding to the first information is greater than the number of acquisitions of a specific or a plurality of information, the first information may be moved to a storage location before the storage location(s) of the specific or the plurality of information. Thus, the processing unit may acquire the first information at a relatively fast speed next time, thereby improving the efficiency of the processing unit in acquiring the first information. Accordingly, the efficiency of the user in acquiring the information corresponding to the word from the reading material may be improved, and the efficiency of the user in reading the reading material may be improved.

Further, the aforementioned processing unit may also compare the updated number of acquisitions of the first information with a pre-determined threshold. When the updated number of acquisitions corresponding to the first information is greater than the pre-determined threshold, the first information may then be a hotpot information. Accordingly, the processing unit may store the first information in a buffer zone of the processing unit, such that the processing unit may acquire the first information at a fast speed. Thus, the efficiency of the processing unit in acquiring the first information may be improved.

In the information acquisition method provided by the present disclosure, after the processing unit acquires the first information corresponding to the to-be-processed information identifier, the number of acquisitions of the first information may be updated. Thus, the processing unit may, according to the updated number of acquisitions corresponding to the first information, update the storage location of the first information in the processing unit.

Accordingly, the processing unit may acquire the first information at a relatively fast speed the next time, thereby improving the efficiency of the processing unit in acquiring the first information. Thus, the efficiency of the user in acquiring the information corresponding to the word from the reading material may be improved, and the efficiency of the user in reading the reading material may be improved.

In another embodiment of the present disclosure, the to-be-processed file may also include an identifier of the illumination device. Then, after the S105, the method may further include generating, by the processing unit, a learning note. The learning note may include the to-be-processed information identifier, the first information corresponding to the to-be-processed information identifier, and the identifier of the illumination device.

By using this method, the user may look up the learning note stored in the processing unit at any time via a mobile terminal or a computer, thus looking up the first information corresponding to the to-be-processed information identifier acquired by the illumination device. Accordingly, the user may no longer need to manually record the first information corresponding to the to-be-processed information identifier, thereby improving the user experience. Simultaneously, the user may also send certain to-be-processed information identifiers and the first information corresponding to the certain to-be-processed information identifiers via the mobile terminal or the computer to the processing unit, thus enriching the information stored in the processing unit.

Those ordinarily skilled in the art may understand that, all or a part of the steps in the aforementioned method embodiments may be realized via hardware related to the program commands. The aforementioned program may be stored in a computer readable storage medium, and when the program is being executed, the steps of the aforementioned method embodiments may be executed. Further, the aforementioned storage medium may include all kinds of media that stores programming codes, such as ROM, RAM, magnetic discs, or optical discs.

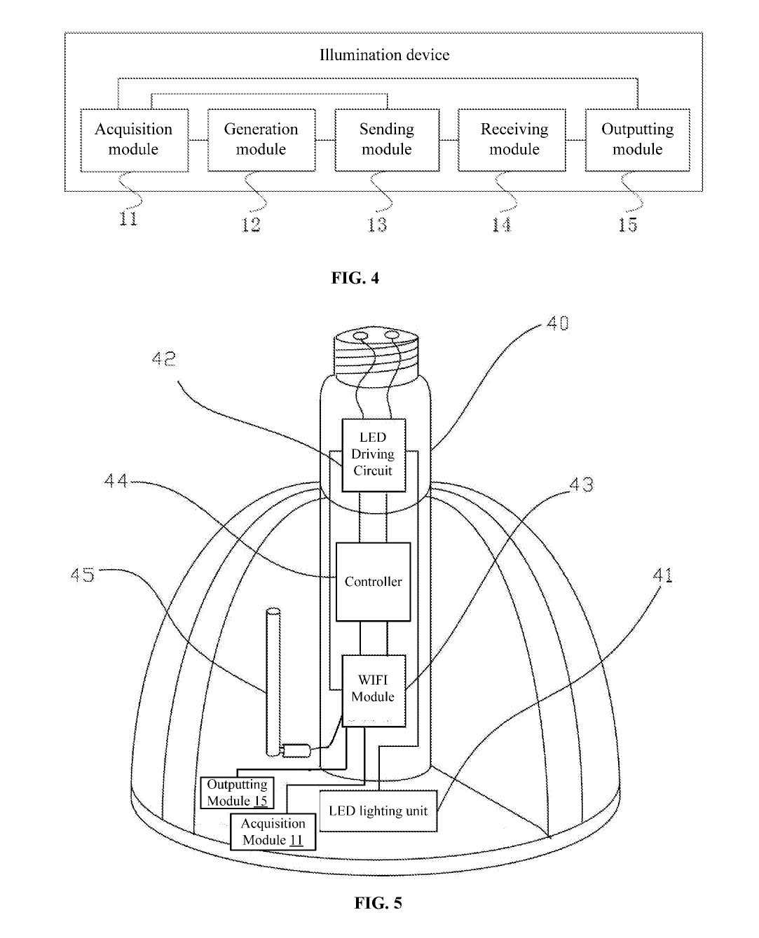

FIG. 4 illustrates a structural schematic view of an illumination device consistent with various disclosed embodiments. As shown in FIG. 4, the illumination device may include an acquisition module 11, a generation module 12, a sending module 13, a receiving module 14, and an outputting module 15.

In particular, the acquisition module 11 may be used to acquire the input command inputted by the user, and the input command may include the to-be-processed information identifier. In particular, the to-be-processed information identifier may be words, digits, or symbols, etc.

The generation module 12 may be used to, according to the input command acquired by the acquisition module 11, generate the to-be-processed file. The to-be-processed file may include the to-be-processed information identifier, and the to-be-processed file may be used to instruct the processing unit to acquire the first information corresponding to the to-be-processed information identifier.

The sending module 13 may be used to send the to-be-processed file generated by the generation module 12 to the processing unit. The receiving module 14 may be used to receive the first information corresponding to the to-be-processed information identifier sent by the processing unit. The outputting module 15 may be used to output the first information received by the receiving module 14.

The disclosed illumination device may execute the aforementioned method embodiments, and the implementation principles and technical effects may be similar to embodiments illustrated above, which are not repeatedly described here.

Further, based on the aforementioned embodiments, the to-be-processed file may also be used to instruct the processing unit to send the first identifier to the illumination device. The first identifier may be an identifier extracted from the to-be-processed file by the processing unit.

Thus, the receiving module 14 may also be used to, before receiving the first information sent by the processing unit, receive the first identifier sent by the processing unit. The outputting module 15 may be used to output the first identifier received by the receiving module 14 to the user. The acquisition module 11 may also be used to acquire the confirmation information inputted by the user. The confirmation information may be used to instruct the illumination device that the first identifier is the to-be-processed information identifier.

The sending module 13 may also be used to, according to the confirmation information acquired by the acquisition module 11, send the processing instruction information to the processing unit. The processing instruction information may be used to instruct the processing unit to acquire the first information according to the first identifier.

The illumination device provided by the present disclosure may execute the aforementioned method embodiments, and the implementation principles and technical effects are similar to embodiments illustrated above, which are not repeatedly described here.

Optionally, the acquisition module 11 may be used to acquire the input command inputted by the user. Specifically, the acquisition module 11 may be used to acquire the input command inputted by the user via a webcam or a microphone. When the acquisition module 11 acquires the input command inputted by the user via the webcam, the to-be-processed file may be an image file. When the aforementioned acquisition module 11 acquires the input command inputted by the user via the microphone, the to-be-processed file may be an audio file.

Optionally, the outputting module 15 may be used to output the first information received by the receiving module 14. Specifically, the outputting module 15 may be used to output the first information received by the receiving module 14 via a speaker device or a display screen.

FIG. 5 illustrates an exemplary configuration of an illumination device consistent with various disclosed embodiments. As shown in FIG. 5, the illumination device 40 may include an LED lighting unit 41, an LED driving circuit 42, a Wi-Fi module 43, a controller 44, an antenna 45, the acquisition module 11, and the outputting module 15. The LED driving circuit 42 may connect to the Wi-Fi module 43, to the LED lighting unit 41, and to the controller 44. The controller 44 may connect to the Wi-Fi module 43 as well. The acquisition module 11 and the outputting module 15 may be connected to the Wi-Fi module 43 and/or the controller 44, respectively. The acquisition module 11 may include a camera, a microphone, and/or a PIR sensor. The outputting module 15 may include a display screen or a speaker.

The Wi-Fi module 43 may work at 2.4 GHz, 5 GHz, or other working frequencies. The Wi-Fi module 43 may be placed inside the illumination device. For example, it may be integrated onto the same circuit board that holds the driving circuit 42. It may also be placed outside the illumination device. The antenna 45 may be a separate antenna that is placed outside the illumination device as shown in FIG. 5. It may also be an integrated antenna and may be placed inside the illumination device. More specifically, the Wi-Fi antenna 45 may be integrated with the Wi-Fi module 43 and be placed on the same PCB board that holds the driving circuit 42.

The controller 44 may be connected to the driving circuit 42. The controller 44 may monitor the LED light operating status such as whether the device is on or off, or light intensity measurements. The controller 44 may also send data received by the Wi-Fi module 43 to the LED driving circuit 42 to control the LED lighting unit 41 including switching lighting on/off, adjusting light intensity and light color, etc. Moreover, the controller 44 may send Pulse Width Modulation (PWM) signals and analog signals to the light adjusting port at the LED driving circuit 42 directly after it receives a light adjusting instruction sent by the Wi-Fi module 43. In addition, the controller 44 may be a micro controller and/or a digital integrated circuit controller, or it may be an integrated circuit controller, which can be integrated with the Wi-Fi module 43 as shown in FIG. 5.

The LED lighting unit 42 may include several light bulbs or LED strips. These light bulbs may be connected to the same controller, and may be controlled and monitored together or separately.

In various embodiments, the WiFi module 43 may function as the sending module 13 and the receiving module 14 shown in FIG. 4. Further, the controller 44 and/or the Wi-Fi module 43 may function as the generation module 12 to preprocess user command and generate the to-be-processed file. The acquisition module 11 and the outputting module 15 may be placed inside or outside of the illumination device. For example, the microphone may be embedded in an outer shell of the illumination device. The speaker may be placed inside the light bulb.

In some embodiments, the acquisition module 11 and/or the outputting module 15 may be remotely connected to the Wi-Fi module 43. For example, a hand held remote control device may be provided. The remote control device may include control buttons for lighting adjustment functions and a function for information acquisition. The remote control device may include at least one of a camera, a microphone, a speaker, and/or a display screen. When the information acquisition is activated, user may operate the handheld control device to acquire the first information, such as aiming the camera at the text or image that the user wanted to search, or speaking to the microphone to record the question. The remote control device may then send the acquired information to the generation module for generating the to-be-processed file through the Wi-Fi module 43. Alternatively, the remote control device may generate the to-be-processed file itself and send the generated file to the Wi-Fi module 43.

It can be understood that, other than searching text information, the disclosed illumination device may also be used to search images and audios, such as recognizing specific object based on an image input or an audio input.

The illumination device provided by the present disclosure may execute the aforementioned method embodiments, whose implementation principles and technical effects are similar, and are not repeatedly described here.

The present disclosure also provides an illumination system. The illumination system may include an illumination device provided by aforementioned embodiments, and a processing unit. In particular, the processing unit may be used to execute the information acquisition method provided by the aforementioned method embodiments, whose implementation principles and technical effects are similar, which are not repeatedly described here.

Lastly, those embodiments above are used to illustrate technical solutions of the present disclosure, but not to limit the scope of the disclosure. Though, referring to previous embodiments, this embodiment is illustrated in details, those skilled in the art may still understand that technical solutions in the previous embodiments may be modified, or partial or the whole technical characteristics may be equally exchanged. The modification or exchange may not deviate the nature of the corresponding technical solutions from technical solutions of each embodiment.

1. An information acquisition method, comprising:
acquiring, by an illumination device, an input command inputted by a user, the input command including a to-be-processed information identifier;
generating, by the illumination device, a to-be-processed file according to the input command;
sending the to-be-processed file to a processing unit, the to-be-processed file being configured to instruct the processing unit to acquire first information corresponding to the to-be-processed information identifier;
receiving, by the illumination device, the first information sent by the processing unit; and
outputting the first information.

2. The method according to claim 1, wherein:
the to-be-processed file is also configured to instruct the processing unit to send a first identifier to the illumination device, and the first identifier is an identifier extracted from the to-be-processed file by the processing unit, and
before receiving, by the illumination device, the first information sent by the processing unit, the method further comprises:
receiving, by the illumination device, the first identifier sent by the processing unit;
outputting the first identifier to the user;
acquiring, by the illumination device, confirmation information inputted by the user, wherein the confirmation information is used to instruct the illumination device that the first identifier is the to-be-processed information identifier; and
sending, by the illumination device, processing instruction information to the processing unit according to the confirmation information, wherein the processing instruction information is used to instruct the processing unit to acquire the first information according to the first identifier.

3. The method according to claim 2, wherein:
the to-be-processed file is an image file or an audio file.

4. The method according to claim 1, wherein:
the to-be-processed information identifier includes a word, a digit, a symbol, or a combination thereof.

5. The method according to claim 1, wherein receiving, by the illumination device, the input command inputted by the user comprises:
receiving, by the illumination device, the input command inputted by the user via a webcam or a microphone.

6. The method according to claim 1, wherein outputting, by the illumination device, the first information comprises:
outputting, by the illumination device, the first information via a speaker device or a display screen.

7. An information acquisition method, comprising:
receiving, by a processing unit, a to-be-processed file sent by an illumination device, the to-be-processed file including a to-be-processed information identifier, and the to-be-processed file being configured to instruct the processing unit to acquire first information corresponding to the to-be-processed information identifier;
acquiring, by the processing unit, the first information corresponding to the to-be-processed information identifier according to the to-be-processed file; and
sending, by the processing unit, the first information to the illumination device.

8. The method according to claim 7, wherein:
the to-be-processed file is configured to instruct the processing unit to send a first identifier to the illumination device, and the first identifier is an identifier extracted from the to-be-processed file by the processing unit, and
before acquiring, by the processing unit, the first information corresponding to the to-be-processed information identifier, the method further comprises:
extracting, by the processing unit, the first identifier from the to-be-processed file;
sending the first identifier to the illumination device; and
receiving, by the processing unit, processing instruction information sent by the illumination device, the processing instruction information being configured to instruct the processing unit to acquire the first information according to the first identifier.

9. The method according to claim 7, wherein after acquiring, by the processing unit, the first information corresponding to the to-be-processed information identifier, the method further comprising:
updating, by the processing unit, a number of acquisitions of the first information; and
updating, by the processing unit, a storage location of the first information in the processing unit according to an updated number of acquisitions of the first information.

10. The method according to claim 7, wherein:
the to-be-processed file includes an identifier of the illumination device, and
after acquiring, by the processing unit, the first information corresponding to the to-be-processed information identifier, the method further comprising:
generating, by the processing unit, a learning note, the learning note including the to-be-processed information identifier, the first information corresponding to the to-be-processed information identifier, and the identifier of the illumination device.

11. The method according to claim 7, wherein:
the to-be-processed file is an image file or an audio file.

12. The method according to claim 11, wherein when the to-be-processed file is the image file, extracting, by the processing unit, from the to-be-processed file comprises:
performing, by the processing unit, an image recognition process on the image file, and
acquiring the first identifier from the processed image file.

13. An illumination device, comprising:
an acquisition module, configured to acquire an input command inputted by a user, the input command including a to-be-processed information identifier;
a generation module, configured to: according to the input command acquired by the acquisition module, generate a to-be-processed file, the to-be-processed file including the to-be-processed information identifier, and the to-be-processed file being configured to instruct the processing unit to acquire the first information corresponding to the to-be-processed information identifier;
a sending module, configured to send the to-be-processed file generated by the generation module to the processing unit;
a receiving module, configured to receive the first information corresponding to the to-be-processed information identifier sent by the processing unit; and
an outputting module, configured to output the first information received by the receiving module.

14. The illumination device according to claim 13, wherein:
the to-be-processed file is also configured to instruct the processing unit to send the first identifier to the illumination device, the first identifier is the identifier extracted from the to-be-processed fie by the processing unit;
the receiving module is also configured to, before receiving the first information sent by the processing unit, receive the first identifier sent by the processing unit;
the outputting module is also configured to output the first identifier received by the receiving module to the user;
the acquisition module is also configured to acquire the confirmation information inputted by the user, the confirmation information being configured to instruct that the first identifier is the to-be-processed information identifier; and
a sending module is also configured to, according to the confirmation information acquired by the acquisition module, send processing instruction information to the processing unit, the processing instruction information being configured to instruct the processing unit to acquire the first information according to the first identifier.

15. The illumination device according to claim 14, wherein:
the to-be-processed file is an image file or an audio file.

16. The illumination device according to claim 13, wherein:
the to-be-processed information identifier includes a word, a digit, a symbol, or a combination thereof.

17. The illumination device according to claim 13, wherein the acquisition module being configured to acquire the input command inputted by the user comprises:
the acquisition module being configured to acquire input command inputted by the user via a webcam or a microphone.

18. The illumination device according to claim 13, wherein the outputting module being configured to output the first information received by the receiving module comprises:
the outputting module being configured to output the first information received by the receiving module via a speaker device or a display screen.

19. (canceled)
